(19) United States
(12) Patent Application Publication
(10) Pub. No.: US 2008/0041770 A1
(43) Pub. Date: Feb. 21, 2008

(54) System and method for sequencing mail in delivery point order

(75) Inventors: Daryl S. Mileaf, Hanover, MD (US); Patrick J. Cowgill, Crestwood, KY (US); Jason J. Park, Abingdon, MD (US); Jeff Lindhurst, Crofton, MD (US); Sean B. Ledford, Perry Hall, MD (US); Stephanie L. Miskiewicz, Columbia, MD (US); Stanley K. Wakamiya, Ellicott City, MD (US); Charles S. Shaw, Fairfax, VA (US); Bruno L. Cartal, Rockville, MD (US); Emmanuel F. Delbe, Bethesda, MD (US); Jacques J. Petit, Bethesda, MD (US); Pierre J. Campagnolle, Hanover, MD (US); Nicholas R. Basset, Rockville, MD (US); Laurent C. Buffat, Columbia, MD (US)

Correspondence Address: ROTHWELL, FIGG, ERNST & MANBECK, P.C., 1425 K STREET, N.W., SUITE 800, WASHINGTON, DC, 20005, US

(73) Assignee: Northrop Grumman Systems Corporation, Los Angeles, CA (US)

(21) Appl. No.: 11/709,880

(22) Filed: Feb. 23, 2007

Related U.S. Application Data
(60) Provisional application No. 60/776,191, filed on Feb. 24, 2006.

(51) Int. Cl. B07C 3/20

(52) U.S. Cl. 209/584

(57) ABSTRACT

Embodiments of the present invention provide a method of using a multi-input sorting machine for sorting mail in delivery point order.

This application claims the benefit of U.S. Provisional Patent Application No. 60/776,191 filed on Feb. 24, 2006, which is incorporated herein by this reference.

### BACKGROUND OF THE INVENTION

1. Field of the Invention

The present invention relates to systems and methods for sorting mail or other objects.

2. Discussion of the Background

The United States Postal Service (USPS) allows large volume mailers of flat mail to prepare a mailing in a number of formats and sequences. Flat mail typically is comprised of large envelopes, magazines and other periodical mail measuring typically no more than 15×12 inches, and typically no thicker than 1.25 inches.

Typically, flat mail (or “flats”) are prepared in bundles. Bundles are created to allow flats that are destined for the same carrier route or zone to be processed together.

There are a number of preparation schemes that mailers can use in preparing bundles of flats, and each scheme has a mailing cost associated with it. The following is an example of some of the various schemes in which mailers can prepare bundles of flats. The first example scheme is referred to as “3-digit.” In the 3-digit scheme, all mail within the bundle is addressed to a delivery point within a given 3-digit postal zone (this refers to the 1^{st} three digits of a zip code, i.e. 210xx). The mail within the bundle will be distributed to a number of facilities and carrier routes within that zone.

The second example scheme is referred to as “5-digit.” In the 5-digit scheme, all mail within the bundle is addressed to a 5-digit zone. The third example scheme is referred to as “carrier route”. In the carrier route scheme, the bundle contains only mail for a specific carrier within a given 5-digit zone. The last example scheme is referred to as “Line-of-Travel (LOT) and/or Carrier Sequenced (CS).” In the LOT/CS scheme, the bundles have been prepared such that the mail within the bundles is in a sequence for a specific carrier within a zone. LOT mail contains mail in either ascending or descending order for addresses on streets in a close approximation of how the carrier actually delivers the mail. Carrier Sequence mail is prepared in exactly the sequence that the carrier delivers the mail.

Each above scheme is processed by the USPS differently and has an associated processing cost. 3-digit mail is usually cross-docked through postal facilities as a bundle until it arrives at the processing center that serves the 3-digit zone. The bundle is then opened and processed to a 5-digit level and delivered to the post office that serves that 5-digit zone.

5-digit bundles are cross-docked all the way to the processing center that serves the 5-digit zone. Depending on the processing center operations, the bundle may be delivered to the local post office that delivers the mail or may be processed down to the carrier level (separating the mail to the carrier within the deliver office so that the carrier doesn't have to separate the mail). Carrier Route, LOT and Carrier sequence mail are all cross-docked directly to the local post office that delivers the mail.

In all cases, the local carrier “cases” the flats for his route to prepare them for delivery. That is, as carriers receive their flats for the day, they sort them into what is referred to as “delivery point order” or “carrier walk sequence”.

More specifically, casing a set of mail refers to the process of placing each piece of mail in the set into the appropriate cubbyhole in a matrix of cubbyholes. Each cubbyhole in the matrix corresponds to one delivery point on the carrier's route. Thus, by placing each piece of mail into its corresponding cubbyhole and then removing the mail from the cubbyholes in the order in which the carrier traverses his mail route, the carrier can create a bundle of mail that is in carrier walk sequence. Accordingly, the result of the casing operation is that all mail for each address or delivery point in the carrier's route is stacked together in order of delivery point. Thus, when the carrier arrives at a particular delivery point on his/her route, the carrier can simply remove from the “top” of his/her bundle of mail the mail addressed to the particular delivery point.

Because “casing” is a manual process, it can be time consuming and error prone. Therefore, it is desirable to eliminate this casing operation by providing to the carrier a bundle of all of the flats for the carrier's route in delivery point order.

### SUMMARY

This patent describes mail sorting methods using multiple feeder input sorting systems.

In one aspect, an embodiment of the invention provides a mail sorting method that includes the following steps: (a) sorting a batch of regular mail to produce a first set and a second set of regular mail, the first set of regular mail consisting essentially of regular mail addressed to a first set of delivery points and the second set of regular mail consisting essentially of regular mail addressed to a second set of delivery points, the first and second sets of delivery points being disjoint, wherein (i) the first set of mail comprises a first group of mail and a second group of mail, the first group of mail comprising all the mail from the batch of regular mail that is addressed to a first delivery point on a first delivery route, and the second group of mail comprising all the mail from the batch of regular mail that is addressed to a second delivery point on the first delivery route, the second delivery point on the first delivery route immediately following the first delivery point on the first delivery route, and (ii) the second set of mail comprises a third group of mail and a fourth group of mail, the third group of mail comprising all the mail from the batch of regular mail that is addressed to a first delivery point on a second delivery route, and the fourth group of mail comprising all the mail from the batch of regular mail that is addressed to a second delivery point on the second delivery route, the second delivery point on the second delivery route immediately following the first delivery point on the second delivery route; (b) after performing step (a), using the first feeder to input into the sorting machine a first batch of saturation mail, wherein the first batch of saturation mail consists essentially of mail that is addressed to delivery points that are within the first set of delivery points; (c) while using the first feeder to input into the sorting machine saturation mail from the first batch of saturation mail, using the second feeder to input into the sorting machine mail from the third group of mail; (d) sorting the first batch of saturation mail; (e) sorting the third group of mail; (f) after inputting into the sorting machine all of the mail from the third group of mail, using a feeder to input into the sorting machine a second batch of saturation mail, wherein the second batch of saturation mail consists essentially of mail that is addressed to delivery points that are within the second set of delivery points; (g) after inputting into the sorting machine all of the mail from the first batch of saturation mail and while inputting into the sorting machine saturation mail from the second batch of saturation mail, using a different feeder than the one being used in step (f) to input into the sorting machine mail from the first group of mail; (h) sorting the second batch of saturation mail; (i) sorting the first group of mail; (j) after inputting into the sorting machine all of the mail from the first group of mail, using a feeder to input into the sorting machine a third batch of saturation mail, wherein the third batch of saturation mail consists essentially of mail that is addressed to delivery points that are within the first set of delivery points; (k) after inputting into the sorting machine all of the mail from the second batch of saturation mail and while inputting into the sorting machine saturation mail from the third batch of saturation mail, using a different feeder than the one being used in step (j) to input into the sorting machine mail from the fourth group of mail; (l) sorting the third batch of saturation mail; and (m) sorting the fourth group of mail.

Another embodiment provides a mail sorting method that includes: creating a first pass sort plan; feeding a batch of mail into a multi-input sorter; using the sorter to sort the batch of mail according to the first pass sort plan, thereby forming a first set of mail and a second set of mail, the first set of mail comprising a first group of mail and a second group of mail, the first group of mail comprising all the mail from the batch of mail that is addressed to a first delivery point on a first delivery route, and the second group of mail comprising all the mail from the batch of mail that is addressed to a second delivery point on the first delivery route, the second delivery point on the first delivery route immediately following the first delivery point on the first delivery route, and the second set of mail comprising a third group of mail and a fourth group of mail, the third group of mail comprising all the mail from the batch of mail that is addressed to a first delivery point on a second delivery route, and the fourth group of mail comprising all the mail from the batch of mail that is addressed to a second delivery point on the second delivery route, the second delivery point on the second delivery route immediately following the first delivery point on the second delivery route; after sorting the batch of mail according to the first pass sort plan, feeding a first batch of saturation mail into the multi-input sorter using a first input of the multi-input sorter, wherein the first batch of saturation mail does not include any mail that is addressed to a delivery point on the second route; sorting the first batch of saturation mail; after sorting the first batch of saturation mail, feeding a second batch of saturation mail into the multi-input sorter using the first input of the multi-input sorter, wherein the second batch of saturation mail does not include any mail that is addressed to a delivery point on the first route; while feeding the second batch of saturation mail into the multi-input sorter, feeding mail from the first group mail into the multi-input sorter using a second input of the multi-input sorter; and simultaneously sorting the second batch of saturation mail and the mail from the first group of mail.

The above and other features and advantages of embodiments of the present invention, as well as the structure and operation of preferred embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 is a functional block diagram of an example flats sorting system.

FIG. 2 is a flow chart illustrating a process according to another embodiment of the invention.

FIG. 3 is a table illustrating a first-pass sort plan according to another embodiment of the invention.

FIG. 4 is a table illustrating a second-pass sort plan according to another embodiment of the invention.

FIGS. 5A-D illustrate the delivery order sequencing of mail.

FIGS. 6A-C further illustrate a mail sorting process according to an embodiment.

### DETAILED DESCRIPTION

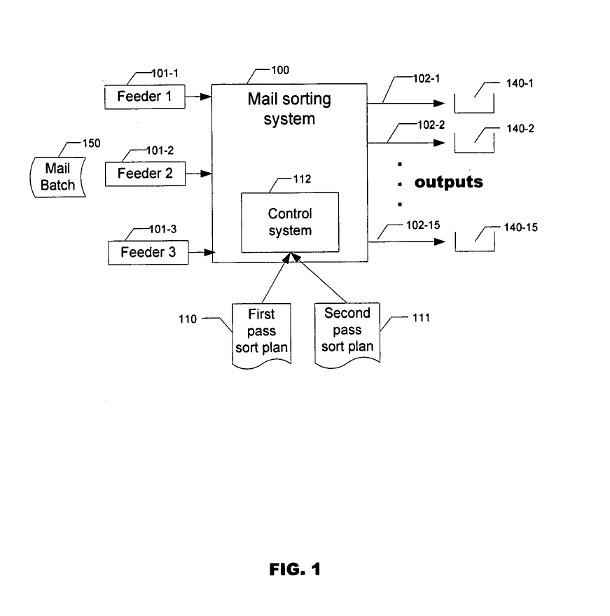

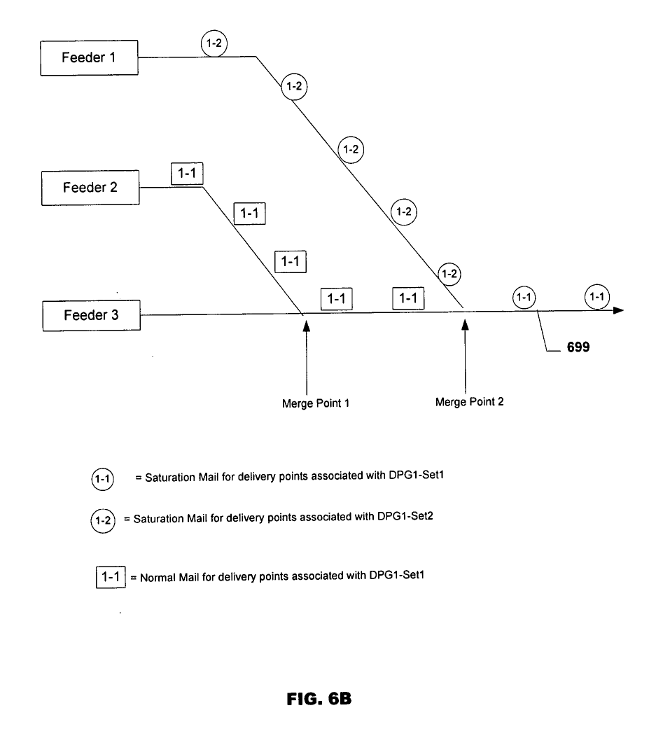

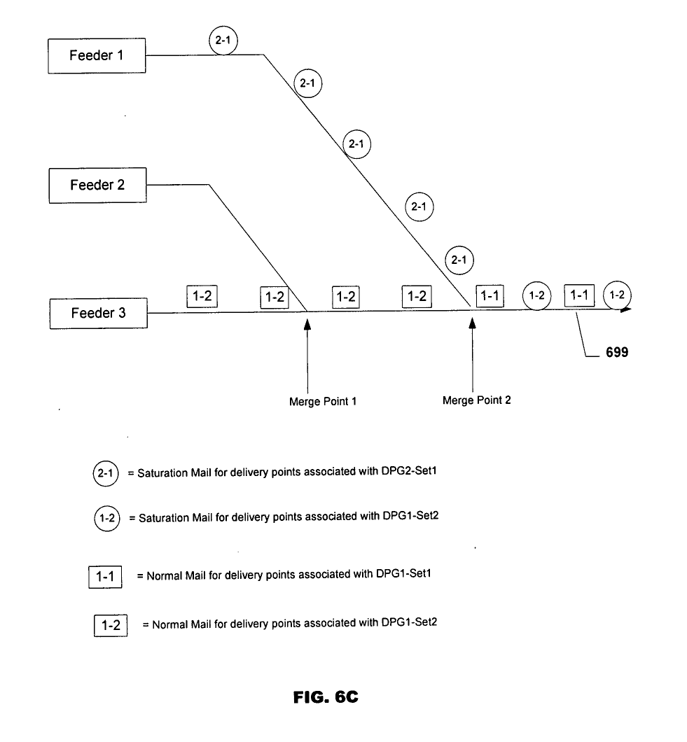

For the sake of illustration and clarity, embodiments of the present invention will described with respect to a mail sorting system 100 (see FIG. 1) having three input feeders 101-1, 101-2, and 101-3 and fifteen outputs 102-1 to 102-15. However, the invention is not limited to this configuration or to any particular mail sorting system or “machine.” The invention may be able to work with a sorting system having M input feeders (M>1) and N outputs (N>1). For example, it is contemplated that one embodiment has 6 input feeders and at least 360 outputs. Any conventional mail sorting system can be used. As shown, one or more trays 140 may be positioned at each output to collect the mail routed to the output. Feeders 101 may feed into a common input line 699 (see FIG. 6A).

As described in U.S. Pat. App. Pub. No. 20050218046, published on Oct. 5, 2005 (the “'046 application”), which is incorporated herein by this reference, system 100 may be partitioned into two or more “virtual systems” by creating a first-pass sort plan 110 that creates X sets of delivery point groups (DPGs), wherein each set is associated with a different set of routes (e.g., a first set of DPGs may be associated with routes 1 and 2 and a second set of DPGs may be associated with routes 3 and 4).

For the sake of clarity, we will describe the “virtual system” embodiment with respect to flat sorting system 100 being partitioned into two virtual machines, one of which is used to sort mail for route-1 and route-2, and the other of which is used to sort mail for route-3 and route-4. However, one skilled in the art will recognize that system 100 may be portioned into more than two virtual machines and may be used to sort mail for more than four routes.

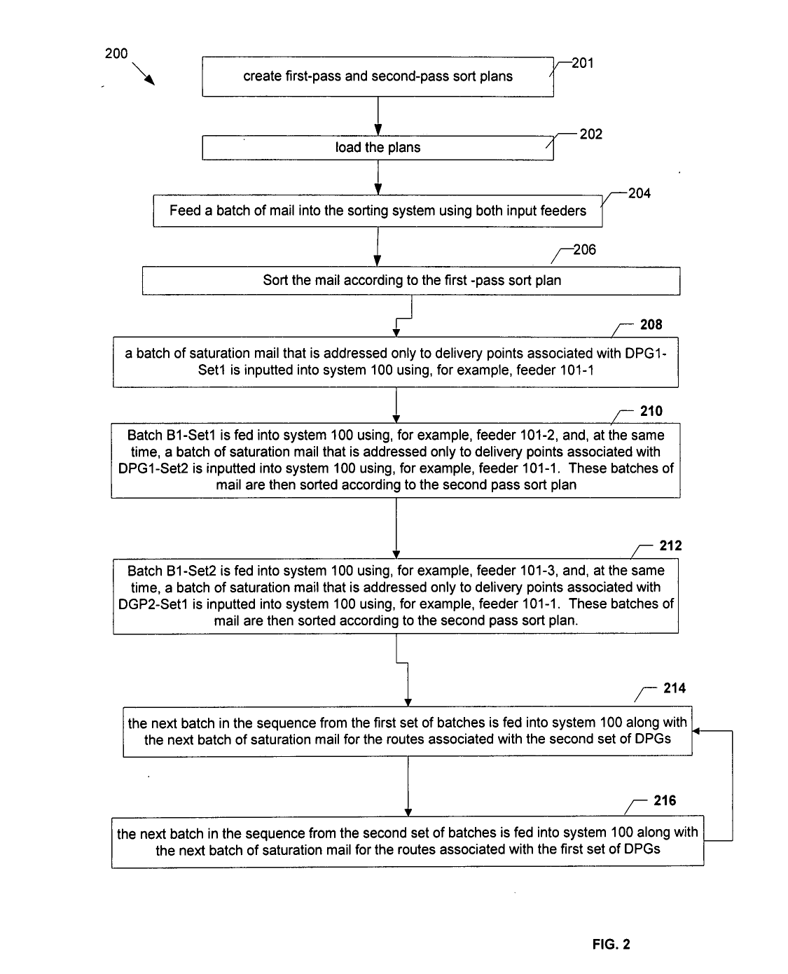

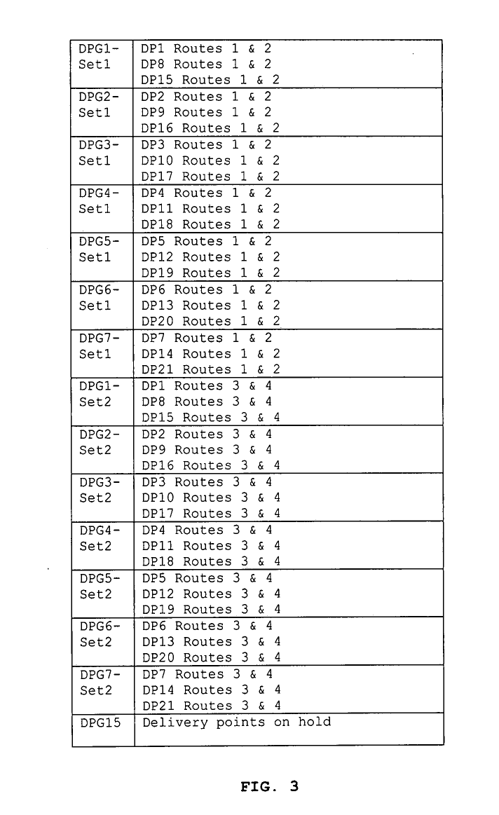

FIG. 2 is a flow chart illustrating a two-pass sorting method 200 that is used when system 100 is partitioned into two virtual machines. Process 200 begins in step 201, where a first-pass and second-pass sort plan is created. For the first pass of a batch of mail through system 100, the first-pass sort plan specifies two sets of seven delivery point groups for a total of fourteen delivery point groups. FIG. 3 illustrates the two sets of seven delivery point groups specified by the first-pass sort plan: a first set 301 and second set 302.

The set of delivery points (“DPs”) included in delivery point group J (0<J<=7) of the first set of delivery point groups 301 is: DPk-RTi, where i=1,2; k=(0)N+J, (1)N+J, . . . , (M)N+J; N is the number of groups in the set (in this case N=7); and M=[ceiling(MAX/N)−1], where MAX is the maximum number of delivery points per carrier route, which in this example is 21. Thus, for example, delivery point group 2 in the first set of DPGs (i.e., “DPG2-SET1”) includes the following DPs: DP2-RT1, DP2-RT2, DP9-RT1, DP9-RT2, DP16-RT1, and DP16-RT2.

Similarly, the set of delivery points included in delivery point group J (0<J<=7) of the second set of delivery point groups 302 is: DPk-RTj, where j=3,4. Thus, for example, delivery point group 2 in the second set of DPGs (i.e., “DPG2-SET2”) includes the following DPs: DP2-RT3, DP2-RT4, DP9-RT3, DP9-RT4, DP16-RT3, and DP16-RT4.

As is illustrated, each delivery point belonging to any one of the DPGs within the first set of DPGs is either on the first route or the second route, and each delivery point within any one of the DPGs within the second set of DPGs is either on the third route or the fourth route. That is the first set of DPGs 310 is associated with routes 1 and 2, and the second set of DPGs 320 is associated with routes 3 and 4.

Advantageously, the sort plan may also specify a fifteenth delivery point group (DPG15). DPG15 may specify, among other things, a set of delivery points to which mail should not be delivered.

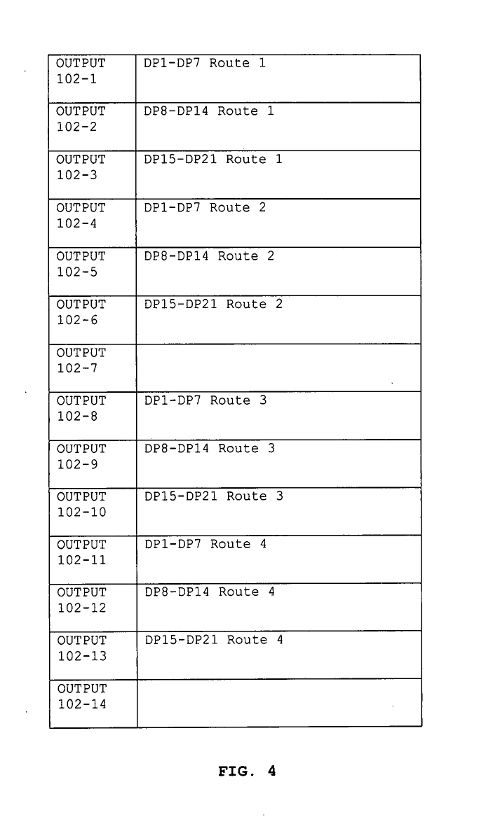

For the second pass, a second-pass sort plan 111 assigns to twelve of the fifteen outputs 102 a set of delivery points for a given route. This is illustrated in FIG. 4. For example, as shown in FIG. 4, DP1-DP7, DP8-DP14, and DP15-DP21 on route-1 are assigned to outputs 102-1, 102-2 and 102-3, respectively; DP1-DP7, DP8-DP14, and DP15-DP21 on route-2 are assigned to outputs 102-4, 102-5 and 102-6, respectively; DP1-DP7, DP8-DP14, and DP15-DP21 on route 3 are assigned to outputs 102-8, 102-9 and 102-10, respectively; and DP1-DP7, DP8-DP14, and DP15-DP21 on route 4 are assigned to outputs 102-11, 102-12 and 102-13, respectively.

In step 202, the first-pass and second-pass sort plans are loaded into the control system 112. In step 204, a batch of mail 150 is fed into system 100 using one or more of the input feeders 101. Preferably, each piece of mail in the batch is addressed to a delivery point on one of the four routes 1-4.

In step 206, controller 112 controls system 100 so that it sorts the batch of mail 150 according to the first-pass sort plan. That is, system 100 may sort the batch of mail 150 into 15 smaller batches according to the first-pass sort plan. More specifically, in the example shown, batch of mail 150 is sorted into a first set of seven batches of mail—corresponding to the first set of DPGs, a second set of seven batches of mail—corresponding to the second set of DPGs, and a 15th batch of mail, which includes all the mail addressed to a delivery point that was assigned to DPG15.

Each one of the seven batches of mail in the first set corresponds to a different one of the DPGs within the first set of DPGs. For the sake of clarity, we will assume that batch N (0<N<=7) from the first set of batches (“BN-Set1”) corresponds to the Nth delivery point group (DPGN) from the first set of DPGs (“DPGN-Set1”). Because BN-Set1 corresponds to DPGN-Set1, all of the mail that is included in BN-Set1 is addressed to a delivery point that is in DPGN-Set1. As a concrete example, every piece of mail that is in B1-Set1 is addressed to a delivery point that is in DPG1-Set1. Referring to FIG. 3, the delivery points that are included in DPG1-Set1 are: DP1-RT1, DP1-RT2, DP8-RT1, DP8-RT2, DP15-RT1, and DP15-RT2.

Similarly, each one of the seven batches of mail from the second set corresponds to a different one of the DPGs within the second set of DPGs. For the sake of clarity, we will assume that batch N (0<N<=7) from the second set of batches (“BN-Set2”) corresponds to the Nth delivery point group (DPGN) from the second set of DPGs (“DPGN-Set2”). Because BN-Set2 corresponds to DBPGN-Set2, all of the mail that is included in BN-Set2 is addressed to a delivery point that is in DPGN-Set2. As a concrete example, every piece of mail that is in B1-Set2 is addressed to a delivery point that is in DPG1-Set2. Referring to FIG. 3, the delivery points that are included in DPG1-Set1 are: DP1-RT3, DP1-RT4, DP8-RT3, DP8-RT4, DP15-RT3, and DP15-RT4.

In one embodiment, system 100 creates the batches B1-Set1, B1-Set2, B2-Set1, B2-Set2, etc . . . by assigning each delivery point on each of the four routes to one of the fourteen outputs according to the delivery point group to which the delivery point belongs in the same manner as disclosed in the '046 application. After step 206, process 200 may proceed to steps 208.

In step 208, a batch of saturation mail that is addressed only to delivery points associated with DPG1-Set1 (i.e., delivery points 1, 8, and 15 on routes 1 & 2) is inputted into system 100 using, for example, feeder 101-1. This batch of mail is then sorted according to the second pass sort plan.

Next, in step 210, batch B1-Set1 is fed into system 100 using, for example, feeder 101-2, and, at the same time, a batch of saturation mail that is addressed only to delivery points associated with DPG1-Set2 (i.e., delivery points 1, 8, and 15 on routes 3 & 4) is inputted into system 100 using, for example, feeder 101-1. These batches of mail are then sorted according to the second pass sort plan.

Next, in step 212, batch B1-Set2 is fed into system 100 using, for example, feeder 101-3, and, at the same time, a batch of saturation mail that is addressed only to delivery points associated with DPG2-Set1 (i.e., delivery points 2, 9, and 16 on routes 1 & 2) is inputted into system 100 using, for example, feeder 101-1. These batches of mail are then sorted according to the second pass sort plan.

Next, in step 214, the next batch in the sequence from the first set of batches is fed into system 100 along with the next batch of saturation mail for the routes associated with the second set of DPGs. For example, if BX-Set1 was the last batch processed from Set1, then B(X+1)-Set1 is the next batch to process since it is the next batch in the sequence. Similarly, if saturation mail for the delivery points associated with DPGX-Set2 was the last batch of saturation mail processed for the routes associated with Set2, then saturation mail for the delivery points associated with DPG(X+1)-Set2 is the next batch of saturation mail to process because it is the next batch in the sequence.

Next, in step 216, the next batch in the sequence from the second set of batches is fed into system 100 along with the next batch of saturation mail for the routes associated with the first set of DPGs. For example, if BX-Set2 was the last batch processed from Set2, then B(X+1)-Set2 is the next batch to process since it is the next batch of mail in the sequence. Similarly, if saturation mail for the delivery points associated with DPGX-Set1 was the last batch of saturation mail processed for the routes associated with Set1, then saturation mail for the delivery points associated with DPG(X+1)-Set1 is the next batch of saturation mail to process because it is the next batch in the sequence. After step 216, the process may proceed to step 214, or the process may end if all the mail from the first pass has been processed.

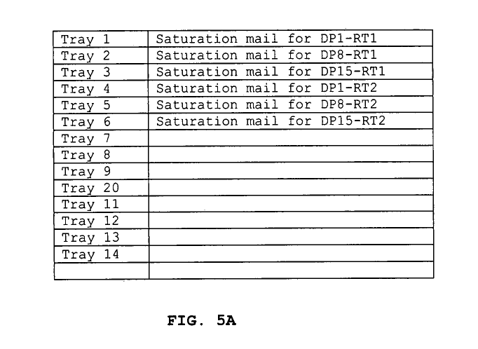

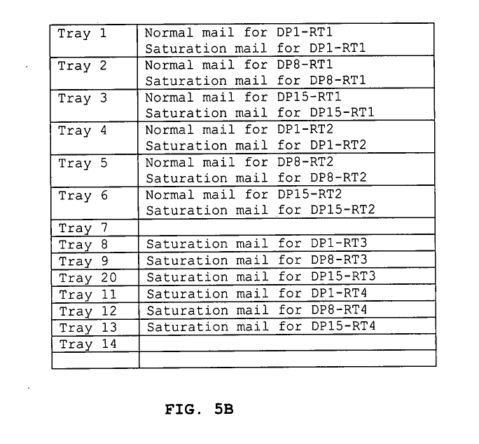

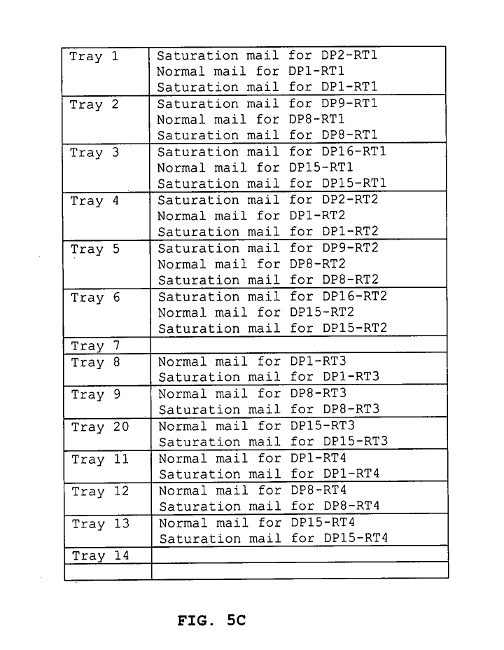

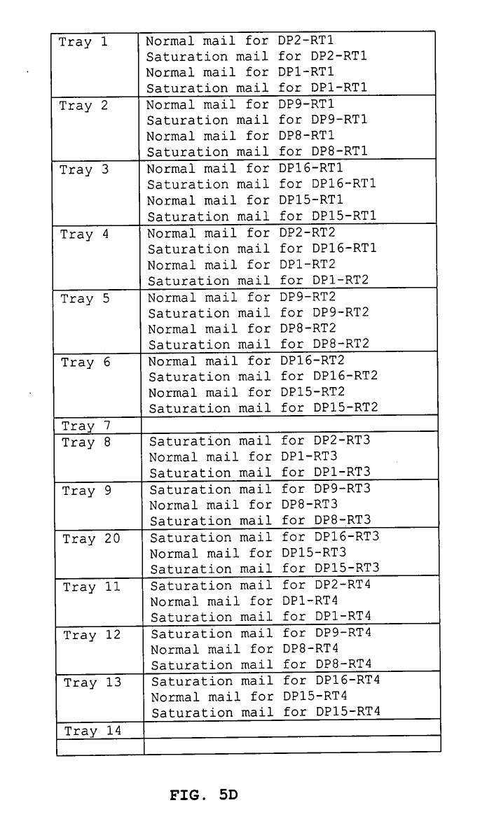

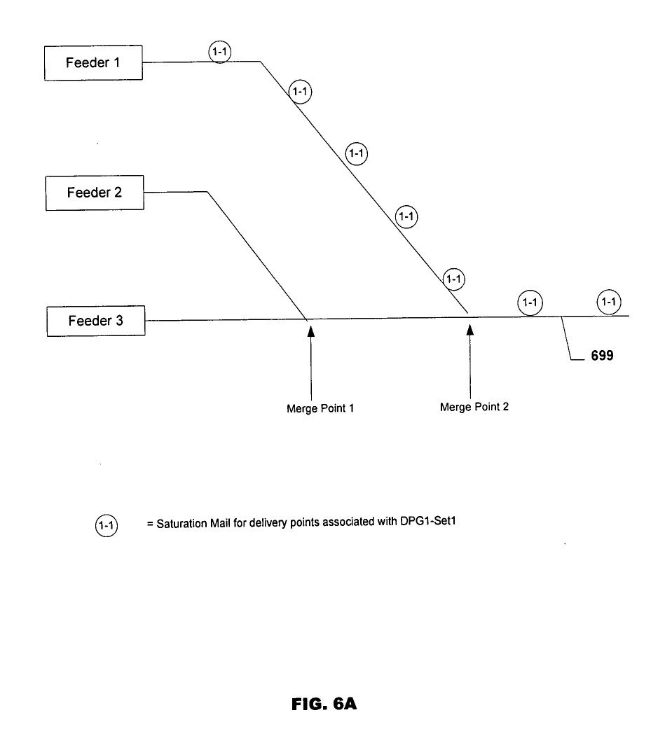

FIG. 5A illustrates the contents of fourteen trays 140-1 to 104-14, where each tray 140-X is positioned to receive the mail routed to output 102-X, respectively, after step 208 is performed. As shown in FIG. 5A, after step 208 is performed, tray 140-1 includes zero or more saturation mail pieces addressed to delivery point DP1-RT1, tray 140-2 zero or more saturation mail pieces addressed to delivery point DP8-RT1, tray 140-3 includes zero or more saturation mail pieces addressed to delivery point DP15-RT1, tray 140-4 includes zero or more saturation mail pieces addressed to delivery point DP1-RT2, . . . , and tray 140-6 includes zero or more saturation mail pieces addressed to delivery point DP15-RT2. As you will notes, trays 140-7 through 140-14 are empty.

FIG. 5B illustrates the contents of trays 140-1 to 104-14 after step 210 is performed. As shown in FIG. 5B, after step 210, tray 140-1 further includes all mail addressed to delivery point DP1-RT1, tray 140-2 further includes all mail addressed to delivery point DP8-RT1, tray 140-3 further includes all mail addressed to delivery point DP15-RT1, tray 140-4 further includes all mail addressed to delivery point DP1-RT2, . . . , tray 140-6 further includes all mail addressed to delivery point DP15-RT2, and trays 140-8 to 140-13 include zero or more saturation mailings for delivery points DP1-RT3, DP8-RT3, DP15-RT3, DP1-RT4, DP8-RT4, and DP15-RT4, respectively.

FIG. 5C illustrates the contents of trays 140-1 to 104-14 after step 212 is performed. As shown in FIG. 5C, after step 212, trays 140-1 to 140-6 further include zero or more saturation mailings for delivery points DP2-RT1, DP9-RT1, DP16-RT1, DP2-RT2, DP9-RT2, and DP16-RT2, respectively. As further shown, tray 140-8 further includes all mail addressed to delivery point DP1-RT3, tray 140-9 further includes all mail addressed to delivery point DP8-RT3, tray 140-10 further includes all mail addressed to delivery point DP15-RT3, tray 140-11 further includes all mail addressed to delivery point DP1-RT4, . . . , tray 140-13 further includes all mail addressed to delivery point DP15-RT4.

FIG. 5D illustrates the contents of trays 140-1 to 104-14 after step 214 is performed. As shown in FIG. 5D, after step 214 tray 140-1 further includes all mail addressed to delivery point DP2-RT1, tray 140-2 further includes all mail addressed to delivery point DP9-RT1, tray 140-3 further includes all mail addressed to delivery point DP16-RT1, tray 140-4 further includes all mail addressed to delivery point DP2-RT2, . . . , and tray 140-6 further includes all mail addressed to delivery point DP16-RT2. As further shown, trays 140-8 to 140-13 further include zero or more saturation mailings for delivery points DP2-RT3, DP9-RT3, DP16-RT3, DP2-RT4, DP9-RT4, and DP16-RT4, respectively.

FIGS. 6A-C pictorially illustrates a portion of the second pass sorting process (i.e., steps 208-212 or process 200). More specifically, FIG. 6A illustrates step 208, FIG. 6B illustrates step 210, and FIG. 6C illustrates step 212.

As shown in FIG. 6A, in step 208, feeder 101-1 feeds into system 100 saturation mail addressed to the delivery points associated with DPG1-Set1.

As shown in FIG. 6B, in step 210, feeder 101-1 feeds into system 100 saturation mail addressed to the delivery points associated with DPG1-Set2 at the same that feeder 101-2 feeds into system 100 normal mail addressed to the delivery points associated with DPG1-Set1.

As shown in FIG. 6C, in step 212, feeder 101-1 feeds into system 100 saturation mail addressed to the delivery points associated with DPG2-Set1 at the same that feeder 101-3 feeds into system 100 normal mail addressed to the delivery points associated with DPG1-Set2.

As shown in FIG. 1 and FIGS. 6A-C, the feeders 101 may feed into a common input line 199. Two of the feeders (101-2 and 101-3) may process normal mail on both passes and the third feeder 101-1 processes saturation mail (e.g., high density mailings) on pass 2. At any given time, any two of the feeders can be processing and input line 199 has a maximum theoretical throughput of twice the base feeder throughput. In one example, the feeder 101 throughputs are 3 flats per second and mail from the feeders is merged onto the transport line that runs at 6 flats per second. The feeders may be synchronized so that they inject into every other available pitch on input line 199 (i.e., mail on the input line consists of alternating individual mail pieces from each feeder). Feeders 101-2 and 101-3 may process normal mailings and the mail pieces are combined on the transport at merge point 1. Feeder 101-1 processes saturation mailings and these mail pieces combine with the mail pieces from either Feeder 101-2 or Feeder 101-3 at merge point 2.

AS illustrated above, when the second pass through the sorting system 100 begins, the saturation feeder (e.g., feeder 101-1) ‘primes’ the input line 699 by inserting saturation pieces for the first set of delivery points that will processed from the other feeders. By processing these mail pieces first, the saturation mail pieces act as separators in the output trays for each delivery point. After the saturation pieces for each of these delivery points are fed, a feeder associated with those delivery points starts to feed so the mail pieces for those delivery points are placed on top of the saturation mailing for the delivery point in the outputs. While this normal mail feeder is processing, the saturation mail feeder interleaves saturation mail pieces for the next set of delivery points associated with the other feeder. This process is continued with the saturation mail feeder running almost continuously while the other two feeders toggle for each set of delivery points.

This approach can used in a number of configuration variations including but not limited to: two or more feeders; more than two normal mail feeders running simultaneously; more than one high density mail feeder per input line; two, or more high density mail feeders running simultaneously; two or more high density mail feeder running simultaneously with one or more normal mail feeders.

This approach may accomplish the following. First, sensitive saturation mailings are processed only once during a two pass operation, thereby minimizing the potential damage to the mailing. Second, saturation mailings act as separators for the delivery points in the outputs after pass two is completed. The mail for each delivery point (e.g., house or apartment or business) has a saturation mail piece at the bottom of the stack of mail pieces for that delivery point. Since mail pieces are stacked on top of each other during processing and multiple delivery points can end up in the same output container, the saturation mail pieces provide a visual cue for the mail carrier during delivery. Third, by priming the system with saturation mail for the first group of delivery point, the system can then operate using two feeders at a time from that point forward by running one feeder to input the mail associated with the saturation mail that was previously fed while the saturation mail feeder is feeding the saturation mail for the next set of delivery points from the other feeder. This toggling allows the system to operate at nearly full throughput by minimizing the amount of time that input line is operating with only one feeder.

While the processes described herein have been illustrated as a series or sequence of steps, the steps need not necessarily be performed in the order described, unless explicitly indicated otherwise.

Further, while various embodiments of the present invention have been described above, it should be understood that they have been presented by way of example only, and not limitation. Thus, the breadth and scope of the present invention should not be limited by any of the above-described exemplary embodiments.

What is claimed is:

1. In a multi-input sorting machine having a first feeder for inputting mail into the sorting machine and a second feeder for inputting mail into the sorting machine, a mail sorting method for sorting mail in delivery point order, comprising:
(a) sorting a batch of regular mail to produce two sets of regular mail, a first set and a second set, the first set of regular mail consisting essentially of regular mail addressed to a first set of delivery points and the second set of regular mail consisting essentially of regular mail addressed to a second set of delivery points, the first and second sets of delivery points being disjoint, wherein (i) the first set of mail consists of a plurality of groups of mail comprising a first group of mail and a second group of mail, the first group of mail comprising all the mail from the batch of regular mail that is addressed to a first delivery point on a first delivery route, and the second group of mail comprising all the mail from the batch of regular mail that is addressed to a second delivery point on the first delivery route, the second delivery point on the first delivery route immediately following the first delivery point on the first delivery route, and (ii) the second set of mail consists of a plurality of groups of mail comprising a third group of mail and a fourth group of mail, the third group of mail comprising all the mail from the batch of regular mail that is addressed to a first delivery point on a second delivery route, and the fourth group of mail comprising all the mail from the batch of regular mail that is addressed to a second delivery point on the second delivery route, the second delivery point on the second delivery route immediately following the first delivery point on the second delivery route;
(b) after performing step (a), using the first feeder to input into the sorting machine a first batch of saturation mail, wherein the first batch of saturation mail consists essentially of mail that is addressed to delivery points that are within the first set of delivery points;
(c) while using the first feeder to input into the sorting machine saturation mail from the first batch of saturation mail, using the second feeder to input into the sorting machine mail from the third group of mail;
(d) sorting the first batch of saturation mail;
(e) sorting the third group of mail;
(f) after inputting into the sorting machine all of the mail from the third group of mail, using a feeder to input into the sorting machine a second batch of saturation mail, wherein the second batch of saturation mail consists essentially of mail that is addressed to delivery points that are within the second set of delivery points;
(g) after inputting into the sorting machine all of the mail from the first batch of saturation mail and while inputting into the sorting machine saturation mail from the second batch of saturation mail, using a different feeder than the one being used in step (f) to input into the sorting machine mail from the first group of mail;
(h) sorting the second batch of saturation mail;
(i) sorting the first group of mail;
(j) after inputting into the sorting machine all of the mail from the first group of mail, using a feeder to input into the sorting machine a third batch of saturation mail, wherein the third batch of saturation mail consists essentially of mail that is addressed to delivery points that are within the first set of delivery points;
(k) after inputting into the sorting machine all of the mail from the second batch of saturation mail and while inputting into the sorting machine saturation mail from the third batch of saturation mail, using a different feeder than the one being used in step (j) to input into the sorting machine mail from the fourth group of mail;
(l) sorting the third batch of saturation mail; and
(m) sorting the fourth group of mail.

2. The method of claim 1, wherein the step of using a feeder to input into the sorting machine the second batch of saturation mail comprises using the first feeder to input into the sorting machine the second batch of saturation mail.

3. The method of claim 2, wherein the step of using a feeder to input into the sorting machine a third batch of saturation mail comprises using the first feeder to input into the sorting machine the third batch of saturation mail.

4. The method of claim 3, wherein the multi-input sorting machine further includes a third feeder for inputting mail into the sorting machine and the step of using a different feeder than the one being used in step (f) to input into the sorting machine mail from the first group of mail comprises using the third feeder to input into the sorting machine the mail from the first group of mail.

5. The method of claim 4, wherein the step of using a different feeder than the one being used in step (j) to input into the sorting machine mail from the fourth group of mail comprises using the second feeder to input into the sorting machine the mail from the fourth group of mail.

6. The method of claim 5, further comprising:
(n) after inputting into the sorting machine all of the mail from the fourth group of mail, using the first feeder to input into the sorting machine a fourth batch of saturation mail, wherein the fourth batch of saturation mail consists essentially of mail that is addressed to delivery points that are within the second set of delivery points;
(o) after inputting into the sorting machine all of the mail from the third batch of saturation mail and while inputting into the sorting machine saturation mail from the fourth batch of saturation mail, using the third feeder to input into the sorting machine mail from the second group of mail;
(p) sorting the fourth batch of saturation mail; and
(q) sorting the second group of mail.

7. A mail sorting method, comprising:
creating a first pass sort plan;
feeding a batch of mail into a multi-input sorter;
using the sorter to sort the batch of mail according to the first pass sort plan, thereby forming a first set of mail and a second set of mail, the first set of mail comprising a first group of mail and a second group of mail, the first group of mail comprising all the mail from the batch of mail that is addressed to a first delivery point on a first delivery route, and the second group of mail comprising all the mail from the batch of mail that is addressed to a second delivery point on the first delivery route, the second delivery point on the first delivery route immediately following the first delivery point on the first delivery route, and the second set of mail comprising a third group of mail and a fourth group of mail, the third group of mail comprising all the mail from the batch of mail that is addressed to a first delivery point on a second delivery route, and the fourth group of mail comprising all the mail from the batch of mail that is addressed to a second delivery point on the second delivery route, the second delivery point on the second delivery route immediately following the first delivery point on the second delivery route;
after sorting the batch of mail according to the first pass sort plan, feeding a first batch of saturation mail into the multi-input sorter using a first input of the multi-input sorter, wherein the first batch of saturation mail does not include any mail that is addressed to a delivery point on the second route;
sorting the first batch of saturation mail;
after sorting the first batch of saturation mail, feeding a second batch of saturation mail into the multi-input sorter using the first input of the multi-input sorter, wherein the second batch of saturation mail does not include any mail that is addressed to a delivery point on the first route;
while feeding the second batch of saturation mail into the multi-input sorter, feeding mail from the first group mail into the multi-input sorter using a second input of the multi-input sorter; and
simultaneously sorting the second batch of saturation mail and the mail from the first group of mail.

8. The method of claim 7, further comprising feeding mail from the third group of mail into the multi-input sorter using an input of the multi-input sorter after sorting the second batch of saturation mail.

9. The method of claim 8, wherein the step of feeding mail from the third group of mail into the multi-input sorter using an input of the multi-input sorter consists of feeding mail from the third group of mail into the multi-input sorter using a third input of the multi-input sorter.

10. The method of claim 8, further comprising feeding a third batch of saturation mail into the multi-input sorter using an input of the multi-input sorter after sorting all of the mail from the first group of mail and sorting the third batch of saturation mail.

11. The method of claim 10, wherein the step of feeding the third batch of saturation mail into the multi-input sorter overlaps with the step of feeding mail from the third group of mail into the multi-input sorter.

12. The method of claim 10, wherein the step of feeding the third batch of saturation mail into the multi-input sorter using an input of the multi-input sorter consists of feeding the third batch of saturation mail into the multi-input sorter using the first input of the multi-input sorter.

13. The method of claim 10, further comprising feeding mail from the second group of mail into the multi-input sorter using an input of the multi-input sorter after sorting the third batch of saturation mail.

14. The method of claim 13, wherein the step of feeding mail from the second group of mail into the multi-input sorter using an input of the multi-input sorter consists of feeding mail from the second group of mail into the multi-input sorter using the second input of the multi-input sorter.

15. The method of claim 13, further comprising feeding a fourth batch of saturation mail into the multi-input sorter using an input of the multi-input sorter after sorting all of the mail from the third group of mail and sorting the fourth batch of saturation mail.

16. The method of claim 15, wherein the step of feeding the fourth batch of saturation mail into the multi-input sorter using an input of the multi-input sorter consists of feeding the fourth batch of saturation mail into the multi-input sorter using the first input of the multi-input sorter.

17. The method of claim 15, further comprising feeding mail from the fourth group of mail into the multi-input sorter using an input of the multi-input sorter after sorting the fourth batch of saturation mail.

18. The method of claim 17, wherein the step of feeding mail from the fourth group of mail into the multi-input sorter using an input of the multi-input sorter consists of feeding mail from the fourth group of mail into the multi-input sorter using the third input of the multi-input sorter.

19. The method of claim 17, further comprising feeding a fifth batch of saturation mail into the multi-input sorter using an input of the multi-input sorter after sorting all of the mail from the second group of mail and sorting the fifth batch of saturation mail.

20. The method of claim 19, wherein the step of feeding the fifth batch of saturation mail into the multi-input sorter using an input of the multi-input sorter consists of feeding the fifth batch of saturation mail into the multi-input sorter using the first input of the multi-input sorter.

21. The method of claim 19, wherein the step of feeding the fifth batch of saturation mail into the multi-input sorter overlaps with the step of feeding mail from the second group of mail into the multi-input sorter.
